(19) United States
(12) Patent Application Publication
(10) Pub. No.: US 2023/0257403 A1
(43) Pub. Date: Aug. 17, 2023

(54) TETHERED SILACROWN ETHERS AND ION CHANNELING APPLICATIONS THEREOF

(71) Applicant: Barry C. ARKLES, Pipersville, PA (US)

(72) Inventor: Barry C. ARKLES, Pipersville, PA (US)

(21) Appl. No.: 18/110,681

(22) Filed: Feb. 16, 2023

Related U.S. Application Data
(60) Provisional application No. 63/311,252, filed on Feb. 17, 2022.

(51) Int. Cl. C07F 7/18

(52) U.S. Cl. CPC C07F 7/1804

(57) ABSTRACT

Silacrown ethers having at least eleven ring atoms and containing at least one substituted or unsubstituted unsaturated hydrocarbon, peptide, or peptoid substituent on the ring and/or on the silicon atom are provided. Azasilacrown ethers having at least eleven ring atoms and containing at least one substituted or unsubstituted, saturated or unsaturated hydrocarbon, peptide, or peptoid substituent on the ring and/or on the silicon atom are also described.

### CROSS-REFERENCE TO RELATED APPLICATION

This application claims priority to U.S. Provisional Application No. 63/311,252, filed Feb. 17, 2022, the disclosure of which is incorporated herein in its entirety.

### BACKGROUND OF THE INVENTION

The functional behavior of transmembrane ion channels is associated with a broad spectrum of disease states denoted channelopathies. Channelopathies are associated with dysfunction of the ion channels and the proteins that interact with them. Deviations in ion selectivity, gating, conductance, and signal transduction of the channels affect cardiac, renal, synaptic and skeletal muscle organ systems. For example, there are multiple examples of cardiac channelopathies (Schreiber Pharmacology of Potassium Channels, Handbook of Experimental Pharmacology 267, https://doi.org/10.1007/164_2021_513). Within cardiac channelopathies, a particularly intractable class of heart failure is associated with preserved ejection failure (HFpef) which is often associated with sodium-glucose channel dysfunction (McHugh; J of the American College of Cardiology 73(5), 602-611 (2019)). Various motifs of artificial transmembrane ion transporters have demonstrated potential as antibacterial agents. Ions of greatest interest are sodium, potassium, calcium, and chloride. Additionally, zinc and copper are associated with ion channels. The concept of an ion transporter is associated with shuttling an ion across a membrane whereas ion channels are scaffolds that mediate transport across the membrane without significant movements associated with their own translocation.

Crown ethers are cyclic ether compounds consisting of oxygen atoms each separated by two carbon atoms, which may also be described as cyclic oligomers of ethylene oxide with repeat unit —CH₂CH₂O—. Crown ethers are named as “X-crown-Y,” where X is the total number of atoms in the ring and Y is the total number of oxygen atoms. Silacrown ethers contain a silicon atom in the ring between two oxygen atoms, replacing one “CH₂CH₂” unit. In other words, silacrown ethers contain repeating ethylenoxy (CH₂CH₂O) groups in which one of the ethylene CH₂CH₂ groups is substituted (replaced) by a silicon atom. Azasilacrown ethers are analogous to silacrown ethers except that a ring oxygen is substituted by a nitrogen atom.

### SUMMARY OF THE INVENTION

Aspects of the disclosure relate to a silacrown ether having eleven to about twenty-seven ring atoms of which one of the ring atoms is silicon, wherein the silacrown ether contains one alkyl group on the silicon atom and at least one exocyclic substituent on the silicon ring atom and/or on a carbon ring atom, and wherein the at least one substituent is selected from the group consisting of a substituted or unsubstituted, linear, branched, or cyclic, unsaturated hydrocarbon group having about three to about twenty-four carbon atoms, a peptide, and a peptoid.

Further aspects of the disclosure relate to an azasilacrown ether having eleven to about twenty-seven ring atoms of which one of the ring atoms is silicon, wherein the silacrown ether contains one alkyl group on the silicon atom and at least one exocyclic substituent on the silicon ring atom and/or on a carbon ring atom, and wherein the at least one substituent is selected from the group consisting of a substituted or unsubstituted, saturated or unsaturated, linear, branched, or cyclic hydrocarbon group having about three to about twenty-four carbon atoms, a peptide, and a peptoid.

Further aspects of the disclosure relate to a silacrown ether having eleven to about twenty-seven ring atoms of which one of the ring atoms is silicon, wherein the silacrown ether contains a cyclohexyl group on the silicon atom and at least one exocyclic substituent on the silicon ring atom and/or on a carbon ring atom, and wherein the at least one substituent is selected from the group consisting of a substituted or unsubstituted, unsaturated, linear, branched, or cyclic hydrocarbon group having about three to about twenty-four carbon atoms, a peptide, and a peptoid.

### DETAILED DESCRIPTION OF THE INVENTION

Aspects of the disclosure relate to forming ion channels by creating structures in which the channel can assemble with or without association with an existing natural protein ion channel. Synthetic ion channel molecules often carry central macrocyclic units that are derivatives of crown ethers since the cavity size of these moieties can be adjusted to match the ions of interest, as noted for example, by Takagi (Pure & Appl. Chem., 61(9), 1605 (1989)). On the other hand, structures containing crown ethers are associated with high levels of toxicity, both as ion transporters and channel structures, which is likely associated with the highly stable crown ethers creating a continuous un-gated ion flux. This disclosure incorporates silacrowns which have controlled hydrolytic stabilities into ion channels (as opposed to ion transporters).

In one aspect of the disclosure, provided is a silacrown ether having eleven to about twenty-seven ring atoms of which one of the ring atoms is silicon, wherein the silacrown ether contains one alkyl group on the silicon atom and at least one exocyclic substituent on the silicon ring atom and/or on a carbon ring atom, and wherein the at least one substituent is selected from the group consisting of a substituted or unsubstituted, unsaturated, linear, branched, or cyclic hydrocarbon group having about three to about twenty-four carbon atoms, a peptide, and a peptoid.

The silacrown ethers described herein contain eleven to about twenty-seven ring atoms, of which one of the ring atoms is silicon. It may be understood that the non-silicon ring atoms are carbon atoms and oxygen atoms as repeating ethylenoxy (CH₂CH₂O) groups, and that the ring atoms are non-aromatic. Preferably, the ring contains about fourteen to twenty-seven ring atoms, or about fourteen to about twenty ring atoms, such as fourteen, fifteen, sixteen, seventeen, eighteen, nineteen, or twenty ring atoms, most preferably fourteen, seventeen, or twenty ring atoms. The smallest ring, having eleven ring atoms, may be referred to as a sila-1 1-crown-4 ring structure or, alternatively, a 3,6,9,11-tetraoxa-1-silaundecane nucleus. Other exemplary skeletons include, without limitation, sila-14-crown-5 and sila-20-crown-7.

The silacrown ethers described herein contain one alkyl group on the silicon ring atom. The alkyl group may be linear, branched, or cyclic, and may contain one to as many as eight carbon atoms, such as methyl, ethyl, propyl, isopropyl, butyl, n-butyl, t-butyl, pentyl, hexyl, cyclohexyl, heptyl, octyl, etc. The preferred alkyl groups are methyl and cyclohexyl, most preferably methyl and cyclohexyl, described and exemplified below.

The silacrown ethers described herein contain, in addition to one alkyl group on the silicon atom, at least one exocyclic substituent (also referred to herein as a tether), which may be on the silicon atom and/or on a carbon ring atom. These substituents may be substituted or unsubstituted, linear, unsaturated, linear, branched, or cyclic, hydrocarbons, such as an unsaturated linear hydrocarbon having at least three and as many as twenty-four carbon atoms, including three, four, five, six, seven, eight, nine, ten, eleven, twelve, thirteen, fourteen, fifteen, sixteen, seventeen, eighteen, nineteen, twenty, twenty-one, twenty-two, twenty-three, or twenty-four carbon atoms, more preferably eight, ten, or twelve carbon atoms (such as octenyl, decenyl, or octadecenyl) or a branched or cyclic unsaturated hydrocarbon having at least three and as many as twenty-four carbon atoms, including three, four, five, six, seven, eight, nine, ten, eleven, twelve, thirteen, fourteen, fifteen, sixteen, seventeen, eighteen, nineteen, twenty, twenty-one, twenty-two, twenty-three, or twenty-four carbon atoms, more preferably about eight, ten, or twelve carbon atoms, including a substituent such as vinylcyclohexyl, shown in an exemplary compound below. Unsaturated hydrocarbons within the scope of the disclosure may include one point of unsaturation, such as an alkene or alkyne, or more than one point of unsaturation, such as a diene. These hydrocarbons may be unsubstituted or substituted with substituents known in the art, including with another silacrown ether as described in more detail below. In preferred embodiments, the silacrown ethers described herein contain an exocyclic substituent (tether) on the silicon atom, so that the silicon ring atom is substituted with a alkyl (such as a methyl or cyclohexyl) group and a tether group; such compounds may additionally contain an additional exocyclic substituent on a carbon ring atom.

In all cases, the tether is of sufficient length to allows self-association of the silacrown in an aqueous medium by hydrophobic interaction. Such association is typically evidenced by micelle or vesicle formation in aqueous systems. Exemplary compounds of this type include n-octadec-1-en-1-ylmethylsila-17-crown-6 (IUPAC name (E,Z)-2-methyl-2-(octadec-1-en-1 yl)tetradecahydrobenzo[d][1,3,6,9,12,15]hexaoxa[2]silacycloheptadecine) and (1,9-decadienyl)methyl]sila-cyclohexano-17-crown-6 (IUPAC name (E,Z)-2-(deca-1,9-dien-1-yl)-2-methyltetradecahydrobenzo[d][1,3,6,9,12,15]hexaoxa[2]silacycloheptadecine), shown below. Without being bound to theory, the formation of micelles or vesicles appears to be indicative of a soft structure of sufficient dimensions to act as a channel in lipid bilayer membranes as well as the more complex membrane structures of living systems.

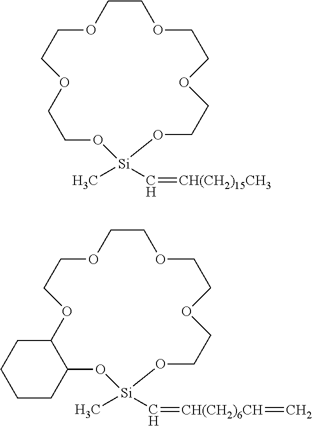

While not within the scope of the invention, the structure of vinylmethylsila-14-crown-5 is shown below for illustrative/didactic purposes only. It is the simplest member of the series and is a potential intermediate but the two-carbon vinyl substitution is of insufficient length for hydrophobic interaction.

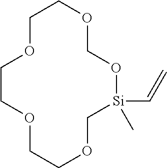 [SMILES: C=C[Si]1(C)COCCOCCOCCOCO1]

The silacrown ethers according to the disclosure may alternatively contain as the exocyclic substituent a terminal peptide or peptoid which has sufficient hydrocarbon substitution to present a structure that is relatively hydrophobic compared to the crown ether, such as, for example, N-acetamidoglycinylundecenyl. An exemplary structure having such an exocyclic substitution is [(N-acetamidoglycinylundecenyl)methyl]sila-17-crown-6, shown below.

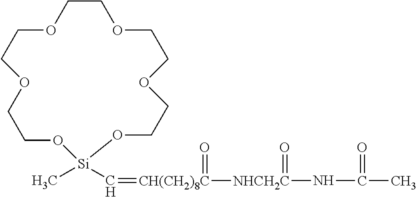

The compounds according to the disclosure include silacrown ethers which contain exocyclic substitutions (tethers) that can lead to interactions with natural ion channels through protein interaction or lead to extended cavity structures by interdigitation of the crown structure with the natural cavity. The tether should be of sufficient length and appropriate structure to have hydrophobic interaction with itself or with the lipophilic portion of the protein that encloses the natural channel and allows extension of the silacrown ether to the ionophoric portion of the channel.

It is also within the scope of the disclosure for the tether to connect two silacrown ethers, such as compounds containing two silacrown ethers which are bridged with, connected by, or linked via a (HC═CH)(CH₂)ₙ(HC═CH)ₘ group, in which n is 0 or an integer from 1 to about 10 and m is 0 or 1. That is, the exocyclic substituent is a (HC═CH)(CH₂)ₙ(HC═CH)ₘ group connected to a silacrown ether, in which n is 0 or an integer from 1 to about 10 and m is 0 or 1.

An exemplary compound of this type, which contains two sila-17-crown-6 rings, has the following structure:

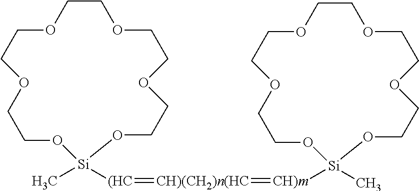

A specific compound of this type (in which n=6 and m=1) has the simple name 1,10-bis(methyl)sila-17-crown-6-diene (IUPAC name deca(1E,Z,9E,Z)-1,10-bis(2-methyl-1,3,6,9,12,15-hexaoxa-2-silacycloheptadecan-2-yl)deca-1,9-diene) and is shown below.

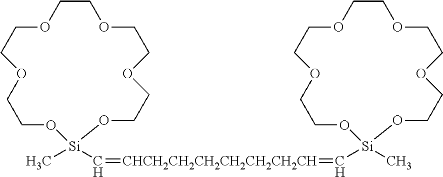

Another exemplary compound of this type (in which n=0 and m=0) is bis(methylsila-14-crown-5)ethene, having the following structure:

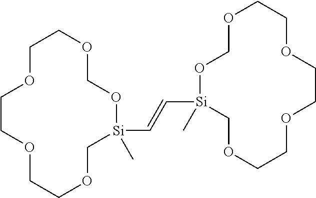 [SMILES: C[Si]1(/C=C/[Si]2(C)COCCOCCOCCOCO2)COCCOCCOCCOCO1]

In these compounds, one silacrown ether contains as an exocyclic substituent an unsaturated linear hydrocarbon which is substituted with a second silacrown ether containing a methyl group on the ring silicon.

It is further within the scope of the disclosure for the silacrown ring to be substituted with one or more linear alkyl (such as, without limitation, methyl or ethyl), cyclohexyl, or other substituents (such as, for example, phenyl or triazole) at one or more of the carbon ring atoms (or bridging two of the carbon ring atoms), such as in the compounds shown below. The compound containing four methyl substituents on the ring is named oct-1-enylmethylsilapentamethyl-14-crown-5.

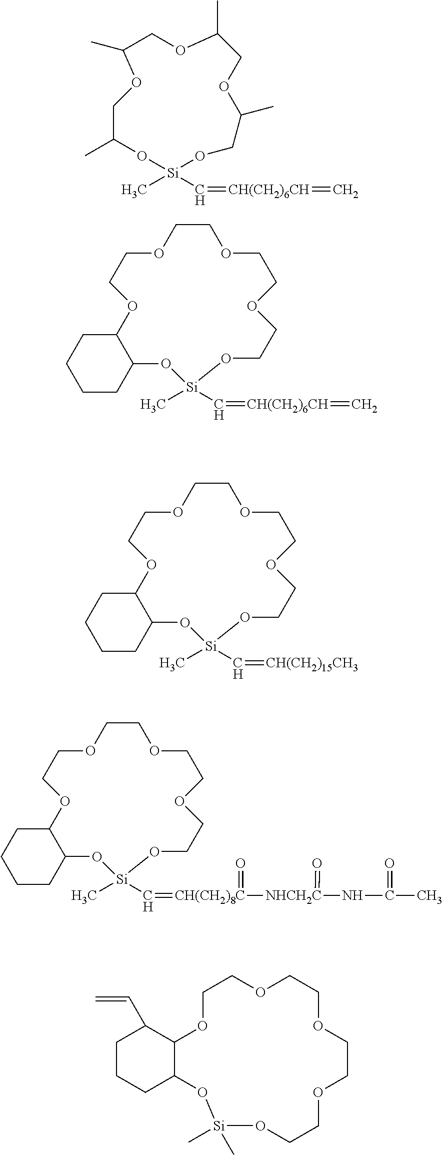

Also within the scope of the disclosure are azasilacrown ethers, which are analogous to silacrown ethers except that a ring oxygen is substituted by a nitrogen atom, which itself may be substituted. Azasilacrown ethers according to the disclosure have eleven to about twenty-seven ring atoms of which one of the ring atoms is silicon, one alkyl group on the silicon atom, and at least one exocyclic substituent on the silicon ring atom and/or on a carbon ring atom, wherein the at least one substituent is selected from the group consisting of a substituted or unsubstituted, saturated or unsaturated, linear, branched, or cyclic hydrocarbon group having about three to about twenty-four carbon atoms, a peptide, and a peptoid. Preferred ring sizes and substituents are as described above; except that the hydrocarbon substituent may additionally be selected from substituted or unsubstituted, saturated, linear, branched, or cyclic hydrocarbon groups having about three to about twenty-four carbon atoms, including three, four, five, six, seven, eight, nine, ten, eleven, twelve, thirteen, fourteen, fifteen, sixteen, seventeen, eighteen, nineteen, twenty, twenty-one, twenty-two, twenty-three, or twenty-four carbon atoms, The azasilacrown ethers may additionally be substituted with one or more linear alkyl (such as, for example, methyl or ethyl), cyclohexyl, or other substituents (such as, for example, phenyl or triazole) at one or more of the carbon ring atoms (or bridging two of the carbon ring atoms), as described above.

An exemplary azasilacrown ether has the following structure:

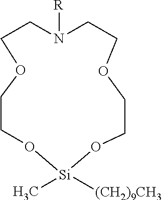

Finally, further aspects of the disclosure relate to a silacrown ether having eleven to about twenty-seven ring atoms of which one of the ring atoms is silicon, wherein the silacrown ether contains a cyclohexyl group on the silicon atom and at least one exocyclic substituent on the silicon ring atom and/or on a carbon ring atom, and wherein the at least one substituent is selected from the group consisting of a substituted or unsubstituted, unsaturated, linear, branched, or cyclic hydrocarbon group having about three to about twenty-four carbon atoms, a peptide, and a peptoid. Preferred ring sizes and substituents are as described above. These compounds may additionally be substituted with one or more linear alkyl (such as, for example, methyl or ethyl), cyclohexyl, or other substituents (such as, for example, phenyl or triazole) at one or more of the carbon ring atoms (or bridging two of the carbon ring atoms). An exemplary silacrown ether of this type has the following structure:

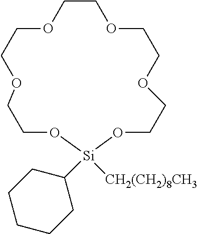

It is noted that these compounds contain a cyclohexyl substituent on the silicon ring atom rather than an alkyl substituent, such as methyl. It is within the scope of the disclosure to vary the substitution on the silicon atom not associated with the tether group to control the desired properties of the compound. For example, considering hydrolytic stability, methyl substitution leads to relatively fast hydrolysis compared to an analogous silacrown with cyclohexyl substitution.

In all cases, the compounds encompassed by the disclosure have a structure in which a channel is formed either in and of itself or by interaction with a natural channel by a combination of hydrophilic, hydrophobic interactions or interdigitation that facilitates the transport of ions across a membrane without the silacrown ether itself being transported across the membrane.

This disclosure is concerned with the tight association of more than one silacrown unit by hydrophobic interaction or covalent bonding to form an ion channel through a membrane in which the crown ether is associated with the membrane structure rather than moving in association with an ion through a membrane or lipid bilayer. The mechanism of the ion channeling described herein is associated with more than one cavity or chelating center associated by hydrophobic or covalent interaction and there can be a mixture of cavities of different size and structure.

The invention will now be described in connection with the following, non-limiting examples.

### Example 1: Synthesis of Vinylmethylsila-14-crown-5

A 250-mL single-necked flask equipped with a magnetic stirrer and heating mantle was charged with 0.5 mol (66.1 g, 74.4 mL) of vinylmethyldimethoxysilane and 0.5 mol (97.1 g, 86 mL) of tetraethylene glycol. 0.3 mL isopropyltitanate was added with stirring. The mixture turned hazy. The mixture was stirred at 50-60° C. for 4 h with a 150 cm packed column and cold finger distillation head in place during which time the mixture became clear pale yellow. The pot temperature was increased to 85-100° C., and about 20 mL of methanol was distilled from the mixture at atmospheric pressure. The mixture was stirred overnight, and distillation resumed; the pot temperature rose to 125-130° C. An additional 7 mls of methanol was distilled from the mixture. Again, the mixture was stirred overnight. An additional 4 mls of methanol was distilled off (total of ˜30 mls) ˜75% of theory. The mixture was again stirred overnight and a vacuum of ˜200 mm Hg was applied and an additional 5 mls of methanol was removed at 35-40° C.

The mixture was then heated under vacuum to ˜200-220° C. The fraction boiling at 110° C.-120° at 0.2 mm was collected. ˜5 mls of volatiles were observed in a dry-ice vacuum trap. Approximately 45 g of vinylmethylsila-14-crown-5 was isolated. It appeared that during the heating in addition to the removal of volatiles present at the onset, more volatiles were formed suggesting redistribution. The title compound was identified by infrared and organic mass spectroscopy.

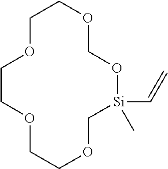 [SMILES: C=C[Si]1(C)COCCOCCOCCOCO1]

### Example 2 (Prophetic): Synthesis of Bis(methylsila-14-crown-5)ethene

According to the method disclosed by Marciniec (Journal of Molecular Catalysis, 76, 30 (1992)) a 100 ml 3-neck flask is equipped with a magnetic stirrer, pot thermocouple, septum port and nitrogen bubbler protected reflux condenser is charged with 26.2 g of vinylmethylsila-14-crown-5. The mixture is heated to 90-100° C. Tris(triphenylphosphine)ruthenium chloride (˜0.5 g) dispersed in 5 mls of toluene is added through the septum. A mild increase in bubble rate at the nitrogen bubbler indicates gas evolution. After 48 hours the mixture is cooled. The condenser is replaced with a distillation head and unreacted vinylmethylsila-14-crown-5 is removed under vacuum under the conditions similar to those of Example 1. The pot contains an impure isomeric mixture of 1,2-bis(2-methyl-1,4,7,10,13-pentaoxa-2-silacyclotetradecan-2-yl)ethene (MW 496.71).

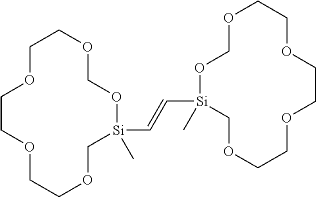 [SMILES: C[Si]1(/C=C/[Si]2(C)COCCOCCOCCOCO2)COCCOCCOCCOCO1]

### Example 3: Synthesis of n-Dec-1-en-1-ylmethylsila-14-crown-5

Conditions similar to those of Example 2 above are employed to produce the title compound, except that n-decene was charged to the flask in addition to the vinylmethylsila-14-crown-5 and the ratio of vinylmethylsilacrown to n-decene is 1:2.

### Example 4: Synthesis of n-Deca-1,9-dien-1-ylmethylsila-14-crown-5

Conditions similar to those of Example 2 above are employed to produce the title compound, except that 1,9-decadiene was charged to the flask in addition to the vinylmethylsila-14-crown-5 and the ratio of vinylmethylsilacrown to n-decadiene is 1:4.

It will be appreciated by those skilled in the art that changes could be made to the embodiment described above without departing from the broad inventive concepts thereof. Also, based on this disclosure, a person of ordinary skill in the art would further recognize that the relative proportions of the components illustrated above could be varied without departing from the spirit and scope of the invention. It is understood, therefore, that this invention is not limited to that particular embodiment disclosed, but it is intended to cover modifications within the spirit and scope of the present invention as defined by the appended claims.

We claim:

1. A silacrown ether having eleven to about twenty-seven ring atoms of which one of the ring atoms is silicon, wherein the silacrown ether contains one alkyl group on the silicon atom and at least one exocyclic substituent on the silicon ring atom and/or on a carbon ring atom, and wherein the at least one substituent is selected from the group consisting of a substituted or unsubstituted, unsaturated, linear, branched, or cyclic, hydrocarbon group having about three to about twenty-four carbon atoms, a peptide, and a peptoid.

2. The silacrown ether according to claim 1, having fourteen to twenty-three ring atoms.

3. The silacrown ether according to claim 1, wherein the exocyclic substituent is N-acetamidoglycinylundecenyl.

4. The silacrown ether according to claim 1, wherein the exocyclic substituent is octenyl, decenyl, or octadecenyl.

5. The silacrown ether according to claim 1, further comprising at least one methyl, ethyl, cyclohexyl, phenyl, or triazole group on at least one carbon ring atom.

6. The silacrown ether according to claim 1, wherein the silacrown ether is n-octadec-1-en-1-ylmethylsila-17-crown-6 having the following structure:

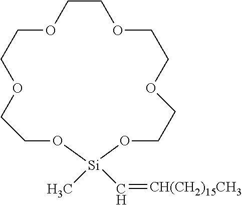

7. The silacrown ether according to claim 1, wherein the silacrown ether is oct-1-enylmethylsilapentamethyl-14-crown-5 having the following structure:

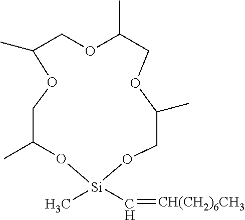

8. The silacrown ether according to claim 1, having the following structure:

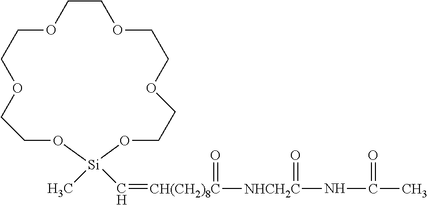

9. The silacrown ether according to claim 1, having the following structure:

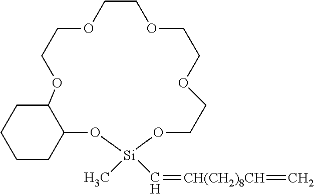

10. The silacrown ether according to claim 1, having the following structure:

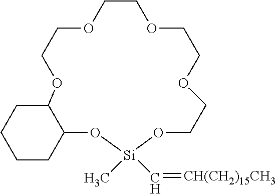

11. The silacrown ether according to claim 1, having the following structure:

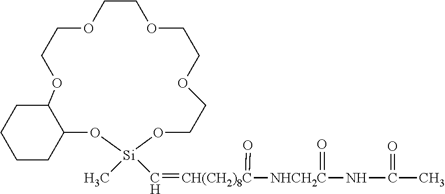

12. The silacrown ether according to claim 1, wherein the silacrown ether is n-dec-1-en-1-ylmethylsila-14-crown-5.

13. The silacrown ether according to claim 1, wherein the silacrown ether is n-deca-1,9-dien-1-ylmethylsila-14-crown-5.

14. The silacrown ether according to claim 1, wherein the exocyclic substituent is a (HC═CH)(CH₂)ₙ(HC═CH)ₘ group connected to a silacrown ether, in which n is 0 or an integer from 1 to about 10 and m is 0 or 1.

15. The silacrown ether according to claim 14, having the following structure:

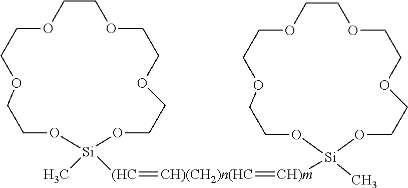

16. The silacrown ether according to claim 14, wherein the silacrown ether is bis(methylsila-14-crown-5)ethene, having the following structure:

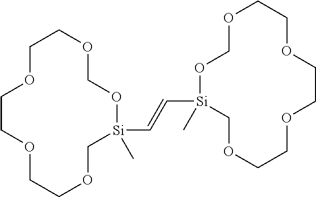 [SMILES: C[Si]1(/C=C/[Si]2(C)COCCOCCOCCOCO2)COCCOCCOCCOCO1]

17. The silacrown ether according to claim 14, having the following structure:

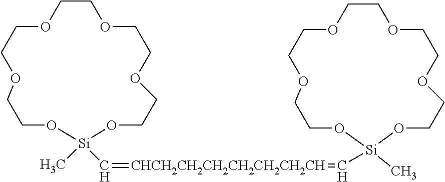

18. The silacrown ether according to claim 1, having the following structure:

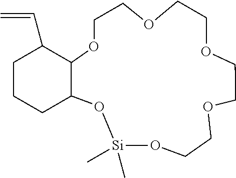 [SMILES: C=CC1CCCC2O[Si](C)(C)OCCOCCOCCOCCOC12]

19. An azasilacrown ether having eleven to about twenty-seven ring atoms of which one of the ring atoms is silicon, wherein the silacrown ether contains one alkyl group on the silicon atom and at least one exocyclic substituent on the silicon ring atom and/or on a carbon ring atom, and wherein the at least one substituent is selected from the group consisting of a substituted or unsubstituted, saturated or unsaturated, linear, branched, or cyclic hydrocarbon group having about three to about twenty-four carbon atoms, a peptide, and a peptoid.

20. The azasilacrown ether according to claim 19, having the following structure:

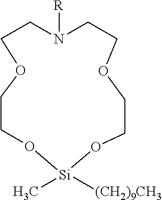

21. A silacrown ether having eleven to about twenty-seven ring atoms of which one of the ring atoms is silicon, wherein the silacrown ether contains a cyclohexyl group on the silicon atom and at least one exocyclic substituent on the silicon ring atom and/or on a carbon ring atom, and wherein the at least one substituent is selected from the group consisting of a substituted or unsubstituted, unsaturated, linear, branched, or cyclic hydrocarbon group having about three to about twenty-four carbon atoms, a peptide, and a peptoid.
